(19) United States
(12) Patent Application Publication
(10) Pub. No.: US 2017/0005339 A1
(43) Pub. Date: Jan. 5, 2017

(54) COPPER FOIL FOR CURRENT COLLECTOR OF LITHIUM SECONDARY BATTERY

(71) Applicant: LS Mtron Ltd., Gyeonggi-do (KR)

(72) Inventors: Dae-Young KIM, Gunpo-si (KR); Byoung-Kwang LEE, Icheon-si (KR); Seung-Jun CHOI, Suwon-si (KR)

(21) Appl. No.: 15/267,525

(22) Filed: Sep. 16, 2016

Related U.S. Application Data
(63) Continuation of application No. 12/962,180, filed on Dec. 7, 2010.

(30) Foreign Application Priority Data
Aug. 10, 2010 (KR) 10-2010-0076976

(51) Int. Cl. H01M 4/66; C23F 15/00; H01M 4/75; H01M 10/0525; C25D 3/38; C25D 1/04

(52) U.S. Cl. CPC H01M 4/661; C25D 3/38; C25D 1/04; H01M 4/75; H01M 10/0525; C23F 15/00

(57) ABSTRACT

A copper foil for a current collector of a lithium secondary battery is configured such that a nodule cluster having an inter-nodule aspect ratio of 0.001 to 2 is provided at a matte side formed on one surface of the copper foil, in aspect of a crystal structure, a ratio of a texture coefficient of a (200) surface to a sum of texture coefficients of a (111) surface and the (200) surface is 30 to 80%, the copper foil has a water contact angle of 90 DEG or below, and impurity spots existing at the surface of the copper foil have a maximum diameter of 100 [mu]m or less, and a minimal spacing distance between the impurity spots is 1 cm or more.

### CROSS-REFERENCE TO RELATED APPLICATIONS

This application is a continuation of U.S. application Ser. No. 12/962,180, filed Dec. 7, 2010, which claims priority under 35 USC 119(a) to Korean Patent Application No. 10-2010-0076976, filed Aug. 10, 2010, the entire contents of which are incorporated herein by reference into this application.

### BACKGROUND OF THE INVENTION

1. Field of the Invention

The present invention relates to a copper foil for a current collector of a lithium secondary battery, and more particularly to a copper foil for a current collector of a lithium secondary battery, which has an improved structure so as to ensure sufficient adhesion between the current collector and an active material of the lithium secondary battery.

2. Description of Related Art

A lithium secondary battery has many advantages such as high energy density, high operation voltage, excellent preservation and excellent life cycle in comparison to other kinds of secondary batteries, so the lithium secondary battery is widely used for various portable electronic devices such as personal computers, camcorders, cellular phones, portable CD players and PDA.

A lithium secondary battery generally includes a cathode and an anode, which are arranged with a separator being interposed between them, and an electrolyte. The cathode and the anode respectively include cathode active material and anode active material, and a cathode current collector and an anode current collector respectively contacted with the cathode active material and the anode active material.

In the lithium secondary battery, a copper foil is mostly used as material of the anode current collector, and the copper foil is generally coated with active material such as carbon-based slurry. Here, the copper foil is made by making an electrodeposited copper foil by means of electroplating and then conducting a post-processing to give peel strength to the original foil. A shiny side having a relatively low surface roughness to give a gloss is formed on one surface of the electrodeposited copper foil by means of electroplating, and a matte side having a high surface roughness but not having a gloss by means of a mountain structure is formed on the other side of the electrodeposited copper foil. Also, the electrodeposited copper foil is surface-treated at a post-processing to form a Cu-nodule cluster at the matte side, thereby having physical and chemical characteristics suitable for a current collector.

The lithium secondary battery exhibits very different adhesion forces between a copper foil and an active material in accordance with the state of the copper foil used as a current collector. In other words, in case the surface of a copper foil 10 is so smooth not to give a good adhesion force as shown in FIG. 1(a), an active material 20 may be separated from the copper foil 10 during a battery assembling work or a battery operating period, which may decrease a battery capacity. In addition, even in case a void 11 is formed at a nodule cluster 30 of the copper foil as shown in FIG. 1(b), an adhesion force may be deteriorated, and charging/discharging current may be concentrated at a certain point.

As a prior art in relation with the improvement of peel strength of a metal plate layer, there is Korean Patent Registration No. 0764300, filed by the applicant of this application. This document discloses a flexible metal clad laminate and its manufacturing method, in which a texture fraction of a (111) surface of a metal conductive layer is 0.5 to 0.65, and a texture fraction of a (200) surface is 0.15 or above.

If the technique disclosed in the above document is applied to a copper foil of a current collector for a lithium secondary battery, peel strength can be improved to some extent. However, since the copper foil for a current collector is contacted with an active material such as carbon-based slurry as mentioned above, an adhesion force should be provided suitably, and it is important to have a surface characteristic capable of preventing creation of a void that makes charging/discharging current be concentrated to a certain point. Thus, there is demanded a copper foil with new configuration suitable for a current collector of a lithium secondary battery.

### SUMMARY OF THE INVENTION

The present invention is designed to solve the problems of the prior art, and therefore the present invention is directed to providing a copper foil of a current collector of a lithium secondary battery, which includes a nodule cluster with an aspect ratio that ensures a sufficient adhesion force with an active material of a lithium secondary battery, and in which factors such as a texture coefficient of a crystal structure, a water contact angle and impurities are optimized.

In one aspect of the present invention, there is provided a copper foil for a current collector of a lithium secondary battery, wherein a matte side is formed on one surface of the copper foil, wherein a nodule duster having an inter-nodule aspect ratio of 0.001 to 2 is provided at the matte side, and wherein the copper foil has a water contact angle of 90° or below.

Preferably, in aspect of a crystal structure, a ratio of a texture coefficient of a (200) surface to a sum of texture coefficients of a (111) surface and the (200) surface is 30 to 80%.

Preferably, in order to prevent deterioration of peel strength, impurity spots existing at the surface of the copper foil have a maximum diameter of 100 μm or less, and a minimal spacing distance between the impurity spots is 1 cm or more.

The copper foil for a current collector of a lithium secondary battery according to the present invention ensures a sufficient adhesion force when being contacted with an anode active material such as carbon-based slurry, thereby ensuring excellent peel strength.

### BRIEF DESCRIPTION OF THE DRAWINGS

Other objects and aspects of the present invention will become apparent from the following description of embodiments with reference to the accompanying drawing in which:

FIG. 1 is a sectional view schematically showing that a conventional copper foil for a current collector of a lithium secondary battery is coated with anode active material;

FIG. 2 is a sectional view schematically showing that a copper foil for a current collector of a lithium secondary battery according to the present invention is coated with anode active material;

FIG. 3 is a SEM (Scanning Electron Microscope) photograph showing a structure of a nodule cluster formed at the copper foil for a current collector of a lithium secondary battery according to one embodiment of the present invention; and

FIG. 4 is a schematic diagram showing a water contact angle that determines wettability of the copper foil for a current collector of a lithium secondary battery according to the present invention.

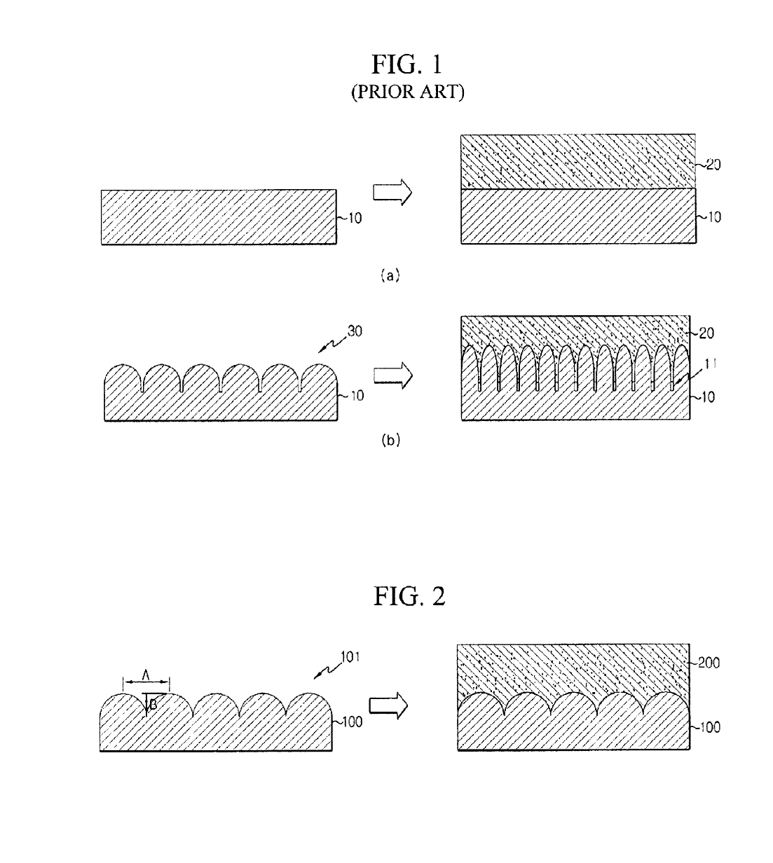

### DETAILED DESCRIPTION OF THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

FIG. 2 is a sectional view schematically showing that a copper foil for a current collector of a lithium secondary battery according to the present invention is coated with anode active material. As shown in FIG. 2, the copper foil 100 for a current collector of a lithium secondary battery according to the present invention is configured such that a nodule cluster 101 is formed at a matte side, and factors such as an aspect ratio of the nodule cluster 101, a texture coefficient, a water contact angle and impurities are optimized such that active material 200 may be closely adhered to the matte side when the copper foil is coated with the active material 200.

In the nodule cluster 101, an aspect ratio (B/A) representing a ratio of a nodule depth (B) to an inter-nodule distance (A) should meet a condition of 0.001 to 2. FIG. 3 shows an actual section of a copper foil at which a nodule cluster structure satisfying the above condition of aspect ratio (B/A) is formed. If the aspect ratio (B/A) of the nodule cluster 101 is less than 0.001, peel strength between the active material 200 and the copper foil 100 is deteriorated lower than an allowable value. If the aspect ratio (B/A) exceeds 2, peel strength is not bad, but a void is created during the coating process of the active material 200, so current is concentrated to a certain point during a charging/discharging process.

A crystal structure of the copper foil 100 should meet a condition that a ratio of a texture coefficient of a (200) surface to a sum of texture coefficients of a (111) surface and the (200) surface is 30 to 80%. This crystal structure can be obtained by controlling additives or plating conditions during an electroplating process used for making the copper foil 100. In detail, in order to obtain the above crystal structure, a plating solution basically contains a copper sulphate plating solution composed of copper sulphate, sulfuric acid and chlorine, and at least two organic additives described below are added within a range of 1 to 50 ppm. The organic additives include compounds with a mercapto group, gelatin-based compounds with a molecular weight of 1,000 to 100,000, or cellulose-based compounds. As a plating condition to obtain the above crystal structure, copper is electrodeposited to a surface of a drum of a foil making machine with a current density of 30 to 80 ASD at a temperature of 30 to 60° C. to make an original foil, and a nodule is formed thereat as necessary. After that, a surface of the copper foil is finally chromate-treated for anti-corrosive treatment.

In case the ratio of texture coefficient exceeds 80%, an adhesion of the active material 200 to the surface of the copper foil is deteriorated. If the ratio is less than 30%, the coating adhesion is good, but elongation is deteriorated. Here, the texture coefficient (TC) is determined by applying X-ray diffraction (XRD) to obtain a peak of diffraction intensity of each crystal surface and then comparing the peak with a criterion peak to convert it within a range of the following equation 1. In the equation 1, I(hkl) represents a measured diffraction intensity with regard to a (hkl) surface, and I0(hkl) represents a standard diffraction intensity of standard powder-shaped diffraction data of ASTM (American Society of Testing Materials).

$$TC ( hkl ) \geq \frac{\frac{I ( hkl )}{{I}_{0} ( hkl )}}{\frac{1}{n} Σ \frac{I ( hkl )}{{I}_{0} ( hkl )}} \qquad Equation 1$$

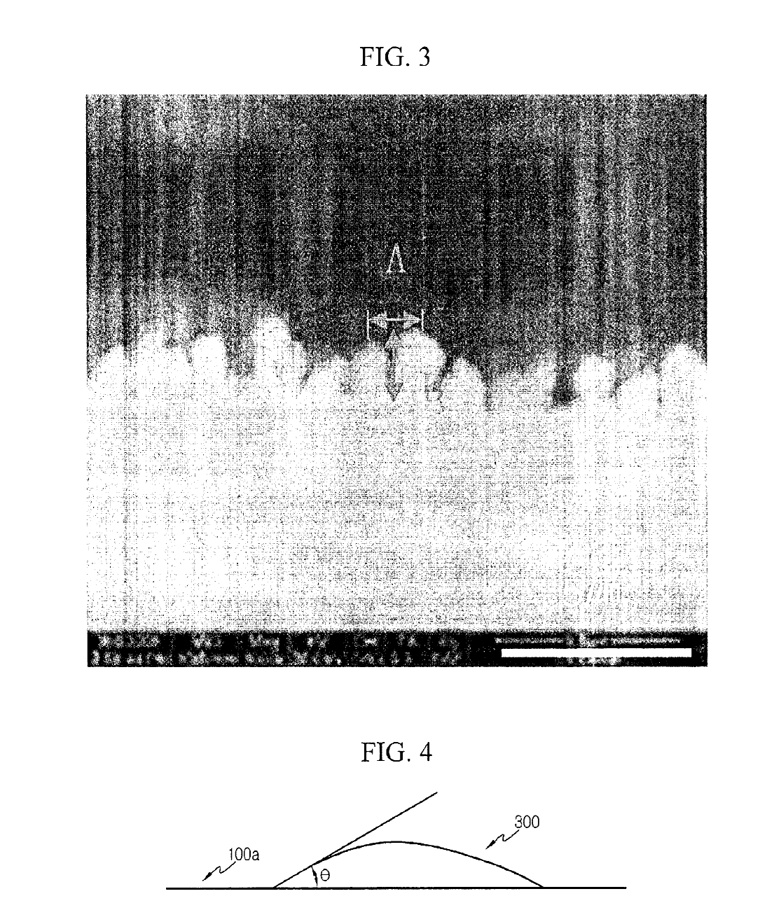

Referring to FIG. 4, a water contact angle (θ) between a surface 100a of the copper foil and a water drop 300, which determines wettability of the copper foil 100, should meet a condition of 0 to 90°. In case the water contact (θ) exceeds 90°, wettability is low, so the coating work of the active material 200 is not properly executed, but its adhesion tends to be deteriorated. The water contact angle (θ) is as good as small within 90°.

Impurity spots existing at the surface of the copper foil 100 should meet conditions that a maximum diameter is 100 μm or less, and a minimal distance between the impurity spots is 1 cm or more. Out of the above ranges, peel strength may be decreased due to impurities at the interface during the coating work of the active material 200.

The following table 1 shows measurement results of peel strength (or, adhesion strength) with respect to a copper foil for a current collector of a lithium secondary battery according to examples 1 to 5 of the present invention and comparative examples 1 to 5.

In Table 1, an aspect ratio (B/A) was calculated by cutting and mounting a copper foil, then obtaining an image of the copper foil with a SEM, measuring A and B as shown in FIG. 3 with respect to 10 points at random, and then converting the measured values into an average value. The adhesion strength was calculated by mixing slurry composed of carboxymethylcellulose (CMC), carbon and rubber (SBR), coating a surface of the copper foil with the slurry, the drying and pressing it to make an electrode, cutting the made electrode into a size of 10 mm×10 cm, and then measuring peel strength of it by using a UTM (Universal Testing Machine). A value of (200)/[(111)+(200)] was calculated by obtaining a texture coefficient of each surface and then converting it into a percentage. The water contact angle was measured by using a water contact angle measurer (Model: DSA100), where a distilled water was dropped, and then water contact angles of the drops were measured for 30 seconds and then averaged.

In the example 1, three kinds of organic additives were added by the content of 5 ppm, respectively to a copper sulfate plating solution containing 80 g/L of Cu, 100 g/L of sulfuric acid and 20 mg/L of chlorine, and then it was made into a foil at 50° C. with a current density of 35 ASD. After that, anti-corrosive treatment was performed thereto.

The examples 2 and 5 were identical to the example 1, except that the current density was set to 45 ASD and 70 ASD, respectively.

The example 3 was identical to the example 5, except that a nodule treatment was performed before the anti-corrosive treatment.

The example 4 was identical to the example 5, except that a nodule treatment was performed before the anti-corrosive treatment. However, a current density of the nodule treatment at this time was 1.2 times of the condition of the example 3.

The comparative example 1 was identical to the example 1, except that a foil was made at 50° C. with 50 ASD, and the foil was made by using a minor-finished substrate.

The comparative example 2 was identical to the example 5, and a nodule treatment was performed before the anti-corrosive treatment. However, a current density of the nodule treatment at this time was 2 times of the condition of the example 3.

The comparative example 3 was identical to the comparative example 1, except that the current density was set to 90 ASD.

The comparative example 4 was identical to the example 1, except that a foil was made at 40° C. with a current density of 70 ASD, and a hydrophobic coating was performed on its surface.

In the comparative example 5, 5 ppm of gelatin was added as an additive to a plating solution with the same composition as in the example 1, and a foil was made at 50° C. with 60 ASD.

TABLE 1

| | Aspect | (200)/ | Water | Adhesion | |
|---|---|---|---|---|---|
| | ratio | [(111) + | contact | strength | |
| | [B/A] | (200)] [%] | angle [°] | [gf/cm] | Note |
| Example 1 | 0.0020 | 32.8 | 69 | 33.1 | |
| Example 2 | 0.0020 | 33.2 | 81 | 33.8 | |
| Example 3 | 1.8000 | 78.7 | 62 | 36.2 | |
| Example 4 | 1.7000 | 68.9 | 86 | 37.1 | |
| Example 5 | 0.5000 | 58.4 | 72 | 35.8 | |
| Comparative | 0.0002 | 53.5 | 84 | 20.8 | |
| example 1 | | | | | |
| Comparative | 2.4000 | 49.7 | 78 | 27.7 | Creation |
| example 2 | | | | | of void |
| Comparative | 1.1000 | 83.6 | 82 | 26.8 | Deteriorated |
| example 3 | | | | | tensile |
| | | | | | strength |
| Comparative | 0.8000 | 54.7 | 105 | 26.9 | Inferior |
| example 4 | | | | | coating |
| | | | | | state |
| Comparative | 0.5000 | 22.4 | 68 | 34.2 | Deteriorated |
| example 5 | | | | | elongation |

Seeing the table 1, it would be understood that the copper foils according to the examples 1 to 5 of the present invention satisfy all conditions of nodule cluster aspect ratio, texture coefficient and water contact angle, thereby exhibiting high peel strength of 33.1 gf/cm or above. Meanwhile, the copper foils according to the comparative examples 1 to 5 have problems such as creation of void, deterioration of tensile strength, inferiority of coating state, deterioration of elongation or the like, so it would be understood that these copper foils are not suitable as being used for a current collector of a lithium secondary battery.

The copper foil for a current collector of a lithium secondary battery according to the present invention may have an improved peel strength if it meets only the condition of a nodule cluster aspect ratio. However, if another condition such as texture coefficient or water contact angle is excessively deviated from the corresponding numerical range as in the comparative examples 3 to 5, bad effects are given to the improved characteristics, thereby finally deteriorating the peel strength characteristic. Thus, it is most preferred that all conditions of nodule cluster aspect ratio, texture coefficient and water contact angle are satisfied.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The copper foil of the present invention may stably maintain a battery capacity and prevent creation of void at a coating work of active material, so it is possible to realize a lithium secondary battery in which current is not concentrated at a specific point of a current collector.

What is claimed is:

1. A copper foil obtained by an electroplating process using a copper sulfate plating solution including copper, sulfuric acid, chlorine and a plurality of organic additives for a current collector of a lithium secondary battery, comprising:
a nodule formed on a surface thereof;
a matte side formed on one surface of the copper foil; and
a shiny side formed on the other surface of the copper foil,
wherein the copper sulfate plating solution including 80 of copper, 100 g/L of sulfuric acid and 20 mg/L of chlorine,
wherein the plurality of organic additives include 5 ppm of a mercapto group compound, 5 ppm of a gelatin-based compound with molecular weight of 1000 to 100000 and 5 ppm of a cellulose-based compound, and the copper foil is obtained under a condition of a current density of 70 ASD at a temperature of 50° C.,
wherein a nodule cluster is formed at the matte side, the nodule cluster having an inter-nodule aspect ratio, which represents a ratio of a nodule depth to an inter-nodule distance, of 1.7 to 1.8,
wherein in aspect of a crystal structure, a ratio of a texture coefficient of a (200) surface to a sum of texture coefficients of a (111) surface and the (200) surface is 68.9 to 78.7%,
wherein the matte side has a water contact angle between the matte side and a water drop, which determines wettability of the copper foil, of 62 to 86,
wherein impurity spots existing at the matte side have a maximum diameter of 100 μm or less, and a minimal spacing distance between the impurity spots is 1 cm or more,
wherein an adhesion strength is 36.2 to 37.1 gf/cm, and
wherein anti-corrosive treatment is performed to the copper foil.
